(19) United States
(12) Patent Application Publication
(10) Pub. No.: US 2005/0187822 A1
(43) Pub. Date: Aug. 25, 2005

(54) Combination memo pad and preprinted prescription script with reusable discount card

(76) Inventor: Joshua Lapsker, Christ Church (BB)

Correspondence Address: KLAUBER & JACKSON, 411 HACKENSACK AVENUE, HACKENSACK, NJ, 07601, US

(21) Appl. No.: 10/881,708

(22) Filed: Jun. 30, 2004

Related U.S. Application Data
(63) Continuation-in-part of application No. 10/865,500, filed on Jun. 10, 2004.
Application No. 10/865,500 is a continuation-in-part of application No. 10/842,835, filed on May 11, 2004.
Application No. 10/865,500 is a continuation-in-part of application No. 10/865,491, filed on Jun. 10, 2004.
Application No. 10/865,491 is a continuation-in-part of application No. 10/785,930, filed on Feb. 24, 2004.

(51) Int. Cl. G06F 17/60

(52) U.S. Cl. 705/14

(57) ABSTRACT

A combination preprinted memo pad and preprinted prescription script assembly with reusable discount card means that facilitates distribution of prescription pharmaceuticals to patients and for encouraging initial and ongoing fulfillment of said prescription by patients.

### RELATED APPLICATION

This application is a Continuation-in-Part of both co-pending application Ser. No. 10/865,500, filed Jun. 10, 2004 (which is a Continuation-in-Part of co-pending application Ser. No. 10/842,835, filed May 11, 2004), as well as co-pending application Ser. No. 10/865,491, filed Jun. 10, 2004 (which is a Continuation-in-Part of co-pending application Ser. No. 10/785,930, filed Feb. 24, 2004), the entirety of each of these applications is hereby incorporated by reference.

### BACKGROUND OF THE INVENTION

1. Field of the Invention

The present invention relates to a combination prescription script and memo pad for physicians that is preprinted, and aids in the dispensing of prescription pharmaceuticals, and further an accompanying reusable discount card for patients receiving a prescription from a physician utilizing the combination prescription script and memo pad.

2. Description of the Related Art

Certain pharmaceuticals are only available to patients with a written prescription from a physician. Typically, the physician writes out a prescription (sometimes known as an “Rx”), for an appropriate medication for a patient, which the patient then takes to a pharmacist who dispenses the medication in accordance with the handwritten prescription.

The current approach to providing complimentary pharmaceuticals can be somewhat problematic. From a drug control standpoint, samples may be lost or stolen at a doctor's office. In terms of safety, samples may become old or expired. Other times, it may be inconvenient for physicians to use samples in their daily practice because of storage space and temperature requirements, or because it is a hassle to retrieve the samples in the course of a hectic day. Moreover, samples are only one time inducements to take a medication at first, and do not offer ongoing incentives for patients, especially those who are concerned about medication costs to continue refilling the prescription.

Also, there is a recurring problem in the ongoing compliance of patients with prescriptions, wherein patients, out of fear of medication costs, often do not fill or refill given prescriptions. This reality is unfortunate: non-compliance in prescription drug taking is putting an enormous strain on the health care system today. Estimates of cost to the United States economy range from 50 to as high as 100 billion dollars per year. It is estimated that 17 percent of all Emergency room visits are the direct result of a prescription drug misdirection (non-compliance). Other results of non-compliance include hospital and nursing home admissions, as well as lost wages and lower productivity. Moreover, the most pressing aspect of non-compliance is reflected in the fact that compliance drops off dramatically when it comes time to refill a prescription. It is known by insurance estimates that for ongoing prescriptions, after one year from beginning a prescription regimen, approximately 60% of patients no longer continue taking or refilling the required medication. This represents an unhealthy dynamic that greatly costs both employers, insurance companies, and society at large greatly over time.

As the population ages, non-compliance becomes a source for even more concern. Population experts say in the year 2003, 83 million Americans were over the age of 50, and by the year 2010, that figure will be over 100 million. In addition, as prescription drugs become more expensive, and as government and employer funded coverage for such drug plans becomes less comprehensive, compliance becomes even more so of a concern for doctors who are concerned about their patients following through with treatments, as well as for insurance companies who wish to reduce the resulting costs of non-compliance, and also for patients who yearn for a less expensive form of compliance.

Currently no system exists to assure long-term compliance in the taking of prescription drugs. Known compliance systems have provided for various methods of notification to ensure compliance. Various methods of such notification include pager systems cable set top boxes for use in homes and adult care centers may enable the broadcasting of reminders but are aimed at providing “strong arm” tactics, such as annoying messages on pagers, set top boxes and the like. Prior art systems do not address the root of the problem in non-compliance, which is motivation, something which is often compromised by ongoing financial concerns associated with prescription fulfillment. While these systems may attempt to provide some form of compliance, none actually encourage or motivate a patient through financial incentives to comply with a drug prescription on a sustainable basis. No prior art system exists to assure realistic, long-term compliance in the taking of prescription drugs. Particularly, none of these systems provide both a means of notification and an incentive for a given prescription medication to be taken.

Moreover, there is a particular problem with distributing such systems to patients. Without ease of use as well as the benefit to a physician, some doctors may tend to forget or otherwise neglect to offer patients such systems. Similarly, without ease of use and significant incentivization, patients will not accept such distributions from doctors, or otherwise will not regularly utilize them, thereby making the problem difficult at both ends of distribution.

As such, if a means were developed to motivate doctors, in the course of providing simplified prescription writing, a practical, convenient way to provide patients with a means to motivate patients to take a prescribed medication, then compliance especially on a long term basis would be greatly enhanced.

### SUMMARY OF THE INVENTION

It is therefore an object of the present invention to provide a system for enabling the convenient dispensing of sample drugs and ongoing discounts as patient prescription fulfillment incentives at the time of the actual writing of a prescription medication by a physician, without the need to bother with samples, separate coupons and/or complex fulfillment notification schemes.

Additional objects, advantages and other novel features of the invention will be set forth in part in the description that follows and in part will become apparent to those skilled in the art upon examination of the following, or may be learned with the practice of the invention.

### BRIEF DESCRIPTION OF THE DRAWINGS

The accompanying drawings which are incorporated in, and constitute a part of the specification, illustrate a preferred embodiment of the invention and, together with the general description given above, as well as the detailed description of the preferred embodiment given below, serve to explain the principles of the invention.

FIG. 1 is an offset view of inventive combination prescription scripts and memo pad assembly with the reusable discount card means included therein in an opened position;

FIG. 2 is an offset view of the inventive combination prescription scripts and memo pad assembly with a focus on a one side of the assembly in an opened position, showing an exemplary rendering of preprinted scripts having the reusable discount card means attached thereto;

FIG. 3 is an offset view of the inventive combination prescription script and memo pad assembly in an opened position, showing an exemplary rendering of a personalized memo pad portion of the assembly from an opposite side of the assembly; and

FIG. 4 is an exemplary up close rendering of a single page of a prescription script and reusable discount card means thereon.

### DETAILED DESCRIPTION OF THE PREFERRED EMBODIMENTS

In its broadest aspect, the present invention relates to a combination prescription script and memo pad assembly with reusable discount card means for prescribing prescription medications and for encouraging their subsequent usage. The invention comprises a preprinted prescription pad having a plurality of preprinted prescription scripts, each preprinted prescription script having a front face, a reusable discount card means detachably affixed to each preprinted prescription script of the preprinted prescription pad, a personalized memo pad having a plurality of personalized memo sheets, each having a front face, wherein the personalized memo pad is attached to the preprinted prescription pad.

According to a preferred embodiment, a pad assembly is provided for a combination of two pads, one which comprises a plurality of preprinted prescription scripts for convenient and reduced-error writing of prescriptions, and a second, comprising a plurality of personalized memo sheets for the convenience of prescribing doctors who wish to jot down information and directions for themselves and/or their patients one embodiment, having at least a physician name and contact information. Attached thereto, most preferably on each individual preprinted prescription script, is a reusable discount card. Reference will now be made in detail to the present preferred embodiment of the invention as illustrated in the accompanying drawings.

With ongoing reference to FIGS. 1, 2, 3 and 4, the combination prescription script and memo pad with reusable discount card means is provided as a pad assembly 1 that comprises a preprinted prescription pad 9 and a personalized memo pad 11, having a front cover 3 identifying a target medication to which the preprinted scripts and reusable discount card are directed, and a back cover 5 for covering the reverse side of the combination assembly. Preprinted prescription pad 9 and personalized memo pad 11 may further include information of advertising inserts 13 and/or 13′ distributed throughout the assembly. Flipping or lifting covers 3, 5 exposes the pads 9, 11 of pad assembly 1. Preferably, the covers 3, 5 will be of a substantially stiff material such as thin, printable cardboard, so as to maintain the condition of the sheets in the pad assembly 1. Markings may be printed on the covers 3, 5 to aid in the identification of the particular medication preprinted on the subject scripts. Each type of sheet preferably includes a means of detachment such as a perforation (not depicted) between each of the plurality of sheets 15, 17 respectively, and the spine 15 that binds a top margin of the totality of sheets in a conventional manner. Moreover, a divider 7 may be further provided for ease of use and rapid access to the sections, which will be most preferably facing in opposite directions.

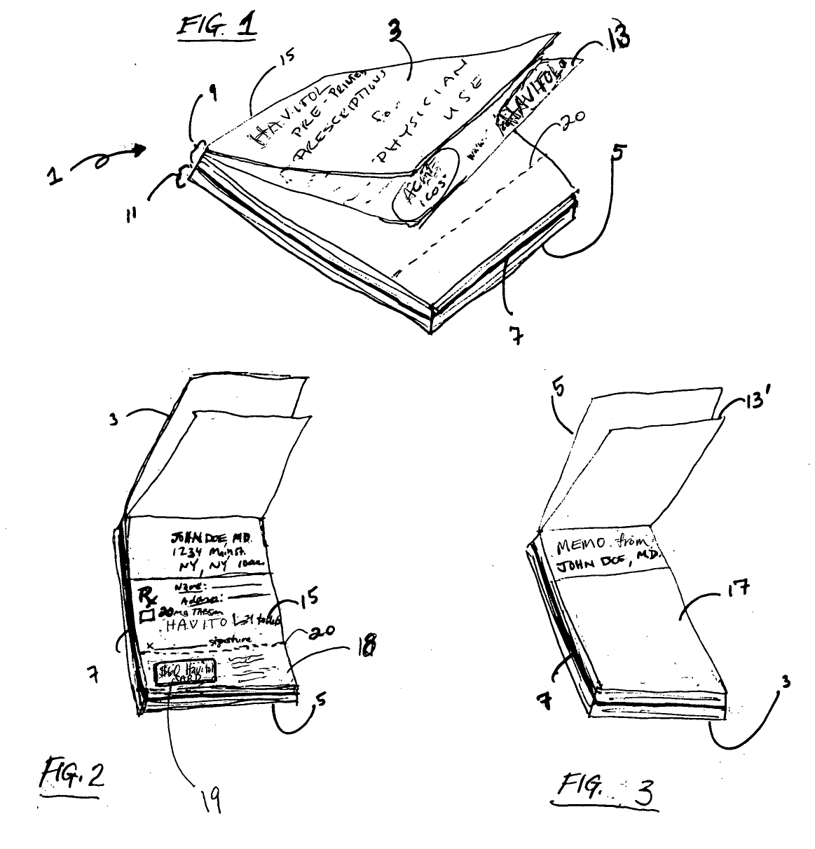

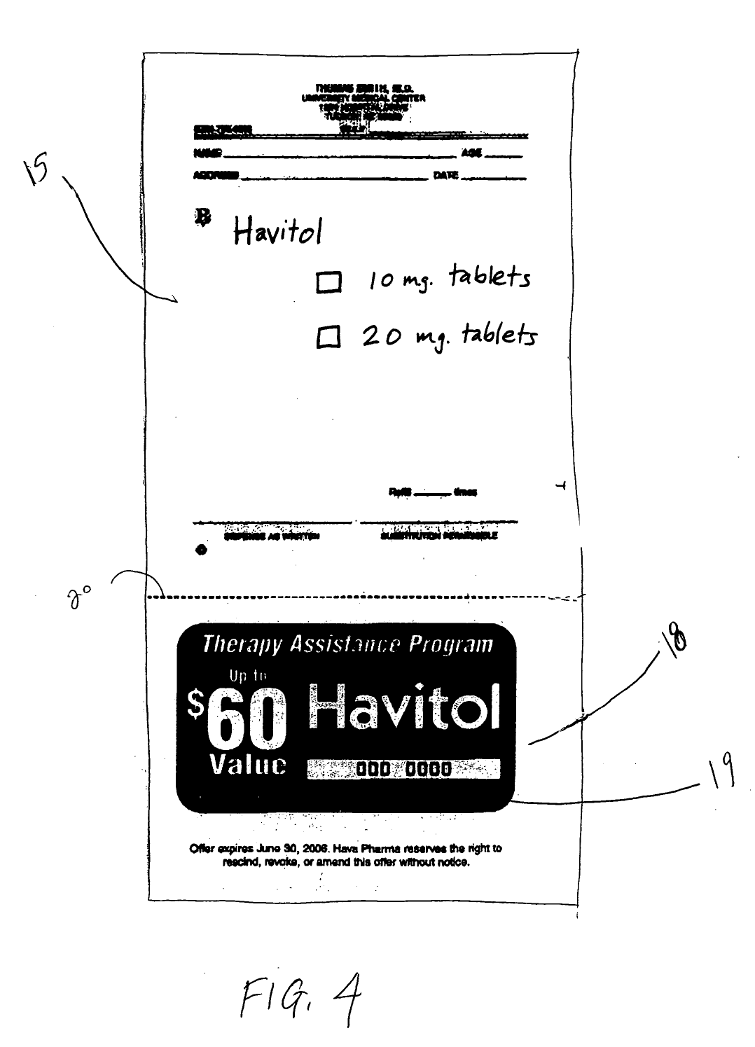

Preprinted prescription pad 9 comprises a plurality of preprinted prescription sheets, or scripts 15. In a particular embodiment as shown, each of the plurality of prescription sheets 15 of the preprinted prescription pad 9 has a preprinted prescription on a front face of the sheet for a particular named medication. The plurality preprinted prescription scripts 15 within a given prescription script pad 9 are all identical. In a particular embodiment, the preprinted prescription scripts 15 may include check-off boxes correlating to predetermined dosage options that can be checked off for the given prescription medicine. For example, as seen in FIG. 4, for a given preprinted prescription script the medication will be clearly printed on the script along with a predefined doseage or range of dosages that may be checked off, so as to avoid common errors that arise from fully handwritten prescriptions. Furthermore, the scripts will have preprinted identifying information of the prescriber (doctor name, address, phone number, etc.), zones for patient name and address, etc., as well as various additional features that may be printed, as needed, considering that the exact information and format of the scripts (e.g., colors, watermarks, required substitution options, and the like) will need to be further provided for on the preprinted script as required by individual state laws.

In a preferred embodiment, detachable paper extension 18, extends from each preprinted prescription script 15, so as to provide for a reusable discount card means 19 to be removably attached thereto. Moreover, detachable paper extension 18 is itself detachably affixed to preprinted prescription script 15, so as to facilitate removal of both the reusable discount card means 19 and the accompanying detachable paper extension 18 from the preprinted prescription script 15 by the patient. This is particularly useful because some patients may wish to retain the detachable paper extension 18, where it may have relevant and/or important information relating to the drug, patient participation sign-up, etc, directly thereon. In a more particular embodiment, reusable discount card means 19 will be detachably affixed to detachable paper extension 18 by a gummed adhesive (or even by means of an additional perforation for separation where the card is made from paper from the detachable paper extension 18), or equivalents thereof, as known in the art for ready detachment. The detachable paper extension 18 can be detachably affixed to preprinted prescription scripts 15 at an extremity, such as at the bottom portion of the front of each individual preprinted prescription scripts 15 on a given preprinted prescription pad 9, the two being separated along a perforation 20. This would permit separation of the detachable paper extension 18 and accompanying reusable discount card means 19 from preprinted prescription script 15 so that a patient could retain both when handing over a preprinted prescription script 15 to a pharmacist when filling a prescription. Much like the preprinted prescription scripts 15, the reusable discount card means 19 may have security enhanced features such as water marks, tracking/security codes, and the like for preventing fraud and/or improper reuse of reusable discount card means 19. Provision as such would most preferably be done so as to print a fraud-resistant, numerically sequenced tracking code that could be correlated with a patient, his data and his prescription needs (procured at an opt-in time as will be described hereafter) so that each given fulfillment or usage at a pharmacy can be associated therewith (by a pharmaceutical benefits processor, also described hereafter) and so that the patient can receive the stated discount at the time of fulfillment.

Provision of the system in this manner offers several advantages. First, the inventive system eliminates the need for physicians to keep track of unattached samples and the need to review expiration dates, or for doctors to keep the samples stored in an accessible, climate controlled environment. Second, it provides better security by the centralizing all storage and physical dispensing of pharmaceuticals at a pharmacy, thereby eliminating or reducing problems and costs associated with theft, inadvertent loss, keeping stocks current, excess packaging, etc. Thirdly, physicians need not keep track of separate cards for distribution to patients in the inventive system, as the cards are included within the combination prescription and memo pad, something which a doctor is predisposed to carry around with him through out the course of the day.

The fulfillment aspect of the present invention stems from the distribution and use of the reusable discount card. In its broadest aspect, the fulfillment and card aspects provides for a prescription drug compliance and discount payment system having at least one reusable discount means 19 having a confidential identification number, a solicitation means associated with each reusable discount means for soliciting a patient consent and patient information, an activation means for receiving said patient consent and patient information received from the solicitation means and for activating a patient participation record related to the confidential identification number, a processor means for receiving the confidential identification number and for receiving a prescription fulfillment transaction, as well as for awarding incentives based on said receipt of each identification number and prescription fulfillment, to patients and participating businesses associated with each said fulfillment transaction, and a compliance means for ensuring a continuing of a prescription compliance of each said patient participation record.

Reusable discount card means 19 provides for a solicitation means through a contact gateway, that might be a toll free number or website for signing up (provided for those who might not wish to sign up by mail). Embossed or typed on the card is a unique identifier and transaction code means for activating and tracking the discount card usage. In order to facilitate widespread usage of the inventive system through existing pharmacy networks, the numeric representation may be simply typed or otherwise entered into an existing pharmacy system for entering and processing secondary insurance-type information for prescriptions.

Accordingly, where a patient consents to enrolling in the discount compliance program, his name, address, indication of consent, preferred means of receiving future reminders, and other information can be received through mail, email, or via phone, by an opt-in center (not depicted) into a database (either through manual data entry input, or through form-based scanning as known in the art) in connection with the reusable discount card means 19. The solicitation/sign up portion will therefore, typically have a confidential identification number contained therein that can be recorded and retained for each subsequent use.

When the card is presented at a pharmacy, the system will be able to correlate information from the solicitation/sign up portion and the card usage thereafter, preferably through the coordinated efforts of a loyalty reimbursement program, opt-in center and a pharmacy benefits processor, such that when the pharmacy benefits processor receives from a pharmacy the confidential identification number that will accompany the transmission of the occurrence of a prescription transaction being fulfilled by the signed upped patient, the confidential number will be used to retrieve stored information from the opt-in center, who can communicate in real time as needed with the other participant entities by sending coded transaction data and reimbursement information data to each other as applicable through regularized, instant transmission of transaction data. Based on the sign up and subsequent fulfillment activity, the patient can be prompted to use the card and avail himself of the discount associated therewith by internet (email) or phone notification, there will be an internet, cable, phone, or other type of preferred connection with the patient for reminding him to fill/refill his prescription. Unless prohibited by law, the pharmacy benefits processor will apply the discount immediately at time of payment at through an electronic credit authorized to the pharmacy. Patient, ideally motivated by the idea of incentives (e.g., preferred discounts stated herein), together with his physician's recommendation, will therefore be inclined to participate, thereby helping to ensure his subsequent (i.e., initial and ongoing) fulfillment of the prescription.

Thereafter, from the confidential identification number received in each transaction, the loyalty reimbursement program, via the pharmacy benefits processor, could correlate the date and time of the prescription being filled with the confidential identification number. The confidential identification number would then enable the correlation by enabling a retrieval of the primary care giver name, address and phone number; patient name, etc. to both verify that a given card is only being used for one patient's medication, and to ensure that it has not expired or exceeded the maximum allowable multiple discounts provided. Thereafter, if the patient does not refill the prescription after a certain number of reminder attempts, the physician may be notified, as needed. Although one persuasive motivation for prescription fulfillment by the patient is based on the discounts applied, this action would additionally motivate the patient to be in compliance. Dates of non-compliance, as well as physician notification might, in certain embodiments, all be recorded in a database. Moreover, such notifications, as well as a broad picture of patient compliance for physicians, would offer further incentives to physicians, who would be distributing such a system in the first place. As mentioned, to further incentivize participating doctors, information regarding patient compliance may be aggregated to form broad pictures of compliance by groupings of patients. Such compliance might then be given to physician as doctor-specific feedback or other type of an informational representation of doctor's patient base compliance. Provision of such information in this manner would be a benefit to physicians for improving or understanding their own practice and/or patient base, as well as for insurance and/or pharmaceutical business purposes.

Further inclusion of the personalized memo pad 11 on the pad assembly, will preferably be in the form of the plurality of memo sheets 17 of the preferred embodiment will have identifying personalized information, such as “MEMO from John Doe, MD.” or the like. In one especially preferred embodiment, the personalized memo pad 11 will be attached to the preprinted prescription pad 9 in an opposite facing direction so as to facilitate access by the doctor. Overall, the configuration of the assembly, especially given the convenience of having personalized memo pad 11 attached, is designed so as to encourage usage by doctors. When structured as such, doctors who desire to jot down additional notes and directions to themselves or patients will then be inclined to use the all-in-one assembly described herein, rather than separate components.

It is to be understood that the invention is not limited to the illustrations described and shown herein, which are deemed to be more illustrative of the best modes of carrying out the invention, and which are susceptible of modification of form, size, arrangement of parts and details operation. These modifications are within the spirit and scope of the appended claims.

1. A combination prescription script and memo pad assembly with reusable discount card means for prescribing prescription medications and for encouraging their subsequent usage comprising:
a preprinted prescription pad having a plurality of preprinted prescription scripts, each said preprinted prescription script having a front face;
a reusable discount card means detachably affixed to each said preprinted prescription script of said preprinted prescription pad; and
a personalized memo pad having a plurality of personalized memo sheets, each having a front face, said personalized memo pad attached to said preprinted prescription pad.

2. The pad assembly of claim 1 wherein at least one of said reusable discount cards is detachably affixed to a front of each of said preprinted prescription scripts by means of a detachable paper extension situated along a bottom of said front of each said preprinted prescription scripts, said detachable paper extensions all being detachable from each said preprinted prescription scripts by means of a tearable perforation means.

3. The pad assembly of claim 2 wherein said reusable discount cards are detachably affixed to said detachable paper extensions by means of gummed adhesive between said cards and said detachable paper extensions.

4. The pad assembly of claim 2 wherein said reusable discount cards are detachably affixed to said detachable paper extensions by means of a tearable perforation between said cards and said detachable paper extensions.

5. The pad assembly of claim 3 wherein said plurality of preprinted prescription scripts are preprinted with a named medication.

6. The pad assembly of claim 5 wherein said plurality of preprinted prescription scripts are preprinted with at least one predetermined dosage selection for said named medication.

7. The pad assembly of claim 6 wherein said reusable discount card means has a stated discount for encouraging initial and ongoing fulfillment of the prescription detailed on the accompanying preprinted prescription script.

8. The pad assembly of claim 7 wherein said card is used for tracking subsequent fulfillment of said prescription by said patient.

9. The pad assembly of claim 4 wherein said plurality of preprinted prescription scripts are preprinted with a named medication.

10. The pad assembly of claim 9 wherein said plurality of preprinted prescription scripts are preprinted with at least one predetermined dosage selection for said named medication.

11. The pad assembly of claim 10 wherein said reusable discount card means has a stated discount for encouraging initial and ongoing fulfillment of the prescription detailed on the accompanying preprinted prescription script.

12. The pad assembly of claim 11 wherein said card is used for tracking subsequent fulfillment of said prescription by said patient.
